(19) United States
(12) Patent Application Publication
(10) Pub. No.: US 2024/0139890 A1
(43) Pub. Date: May 2, 2024

(54) POSITIONING DEVICE FOR CLAMPING OPENING COMPONENT

(71) Applicant: ABB Schweiz AG, Baden (CH)

(72) Inventor: Yonghua Shan, Shanghai (CN)

(21) Appl. No.: 18/548,372

(22) PCT Filed: Mar. 31, 2021
(86) PCT No.: PCT/CN2021/084232

§ 371 Date: Aug. 30, 2023

(51) Int. Cl. B23K 37/04

(52) U.S. Cl. CPC B23K 37/0435

(57) ABSTRACT

A positioning device for clamping an opening component, including a bracket; a guide rod supported by the bracket; a connecting block connected to the guide rod through threads and being capable of translating between a first position and a second position along the guide rod when the guide rod rotates with respect to the bracket; a follower through which the guide rod extends, the follower being capable of translating with respect to the guide rod; a supporting component connected to an end of the follower and configured to support the opening component. The positioning device also includes a pair of pressing arms, wherein each arm includes a clamping part, a first connecting part connected to the connecting block via a hinge, and a second connecting part connected to the follower via a first rotating shaft.

### FIELD

Example embodiments of the present disclosure generally relate to the field of processing devices of opening components, and more specifically, to a positioning device for clamping an opening component.

### BACKGROUND

In the case that an opening component in an automobile, such as a mounting bracket, needs to be welded, the opening component would be first placed on a positioning device and then transferred to a welding position by the positioning deice. Afterwards, a welding gun may be moved near the welding position via a channel and perform the welding on the opening component. There are usually some requirements for the opening size of the opening component. Such requirements of the opening size limit the design space of the positioning device and result in the channel of the welding gun being narrow.

A conventional positioning device typically includes three pneumatic motors. Among these motors, two are used to clamp the opening component and the other one is used to transfer the opening component along a guide rail. However, the size of such a positioning device is usually relatively large, which will occupy a channel of the welding gun and thus have a great impact on the welding accessibility and welding quality. In addition, the structure of such a positioning device is relatively complex and the adjustment of the positioning device is complicated.

Thus, there is a need for an improved solution for positioning the opening components.

### SUMMARY

In view of the foregoing problems, example embodiments of the present disclosure propose a positioning device for clamping an opening component, so as to achieve the positioning and clamping of the opening component in a simple, space-saving, efficient and safe manner.

In an aspect, example embodiments of the present disclosure provide a positioning device for clamping an opening component, comprising: a bracket; a guide rod supported by the bracket and being capable of rotating with respect to the bracket under driving of a motor; a connecting block connected to the guide rod through threads and being capable of translating between a first position and a second position along the guide rod when the guide rod rotates with respect to the bracket; a follower through which the guide rod extends, the follower being capable of translating with respect to the guide rod; a supporting component connected to an end of the follower and configured to support the opening component; and a pair of pressing arms each comprising a clamping part configured to clamp the opening component supported by the supporting component, a first connecting part connected to the connecting block via a hinge, and a second connecting part located between the clamping part and the first connecting part and connected to the follower via a first rotating shaft, such that the pair of pressing arms are in a separating state and the follower is in a retracting state with respect to the bracket when the connecting block is at the first position, and the pair of pressing arms are in a clamping state and the follower is in an extending state with respect to the bracket when the connecting block is at the second position.

In some embodiments, the follower comprises: a first following part connected to the pair of pressing arms and comprising a first hole suitable for insertion of the guide rod, wherein the supporting component is mounted on the first following part; a second following part spaced apart from the first following part and comprising a second hole suitable for insertion of the guide rod; and a third following part arranged between the first following part and the second following part and comprising a notch, wherein the connecting block is received in the notch.

In some embodiments, the positioning device further comprises: a closing block connected to an end of the second following part away from the first following part and comprising a protrusion surrounding the guide rod and partially closing the second hole; and a first spring having an end contacting the connecting block and another end contacting the protrusion of the closing block and configured to be in a compressed state when the connecting block is at the first position and in a free state when the connecting block is at the second position.

In some embodiments, the positioning device further comprises: a first indicating component arranged at a first side of the closing block away from the follower; and a first sensor configured to detect a position of the first indicating component to indicate whether the follower is in the retracting state with respect to the bracket.

In some embodiments, the positioning device further comprises: a second indicating component arranged at a second side of the closing block opposite to the first side; and a second sensor configured to detect a position of the second indicating component to indicate whether the follower is in the extending state with respect to the bracket.

In some embodiments, the supporting component comprises: a plugging block connected to the end of the follower; a pair of restricting elements arranged in the plugging block and being capable of partially protruding out of plugging block; and a second spring arranged between the pair of restricting elements and configured to apply a pushing force to the pair of restricting elements such that the pair of restricting elements partially protrude out of the plugging block to restrict the movement of the opening component supported by the plugging block.

In some embodiments, each of the pair of restricting elements is of a spherical shape.

In some embodiments, each of the pair of pressing arms further comprises a roller arranged close to an edge of the second connecting part and configured to guide the movement of the respective pressing arm with respect to the bracket.

In some embodiments, the first rotating shaft comprises an annular groove, and each of the pair of pressing arms further comprises a stop pin arranged in the second connecting part and inserted into the annular groove.

In some embodiments, the motor is a pneumatic motor.

According to embodiments of the present disclosure, when the motor drives the guide rod to rotate, the connecting block may translate along the guide rod. Since the connecting block is connected to the pressing arms through the hinge and the pressing arms are in turn connected to the follower through the first rotating shaft, the translation of the connecting block will cause the pressing arms to switch between the separating state and the clamping state and cause the follower to switch between the retracting state and the extending state. In this way, the positioning and clamping of the opening component may be implemented synchronously. In addition, the size, structural complexity and cost of the positioning device are greatly reduced due to the synchronous control of the pressing arms and the follower.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure in any manner.

FIG. 1 illustrates a perspective view of a positioning device for clamping an opening component in accordance with an embodiment of the present disclosure;

FIG. 2 illustrates a partial schematic view of the positioning device as shown in FIG. 1;

FIG. 3 illustrates a perspective view of the positioning device as shown in FIG. 1 when being viewed from another direction;

FIG. 4 illustrates a cross sectional view of the positioning device as shown in FIG. 1 in the case that pressing arms are in a separating state; and

FIG. 5 illustrates a cross sectional view of the positioning device as shown in FIG. 1 in the case that the pressing arms are in a clamping state.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The terms “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As described above, the size of the conventional positioning device is usually relatively large, which will occupy a channel of the welding gun and thus have a great impact on the welding accessibility and welding quality; in addition, the structure of the conventional positioning device is relatively complex and the adjustment of the positioning device is complicated. According to embodiments of the present disclosure, a positioning device is provided to implement the positioning and clamping of the opening component synchronously, so as to reduce the size, structural complexity and cost of the positioning device. The above idea may be implemented in various manners, as will be described in detail in the following paragraphs.

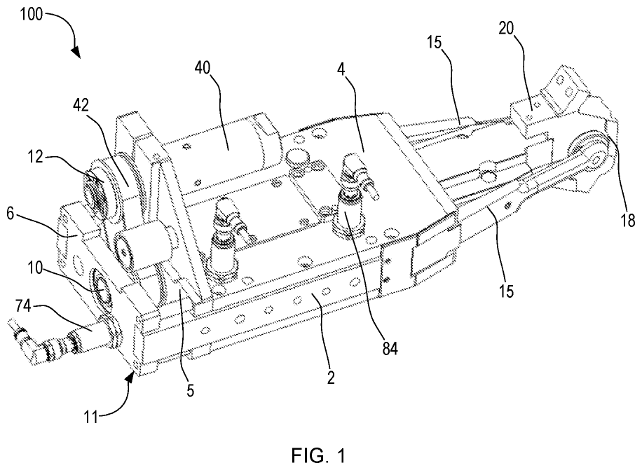

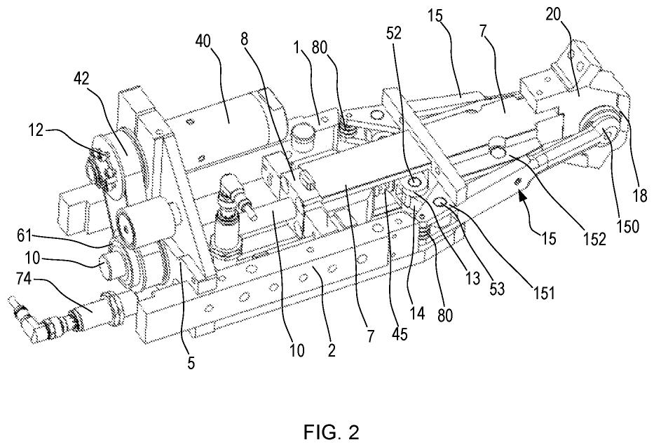

Hereinafter, the principles of the present disclosure will be described in detail with reference to FIGS. 1-5. Referring to FIGS. 1 and 2 first, FIG. 1 illustrates a perspective view of a positioning device 100 for clamping an opening component 20 in accordance with an embodiment of the present disclosure, and FIG. 2 illustrates a partial schematic view of the positioning device 100 as shown in FIG. 1. In FIG. 2, some components of the positioning device 100 are omitted so as to clearly illustrate internal structural details of the positioning device 100.

As shown in FIGS. 1 and 2, the positioning device 100 described herein includes a bracket 11. The bracket 11 is adapted to support and/or receive other components of the positioning device 100. In some embodiments, the bracket 11 includes a first side plate 1, a second side plate 2, a first supporting plate 5, a second supporting plate 6, and a top plate 4. The second side plate 2 is arranged opposite to the first side plate 1. The first supporting plate 5 and the second supporting plate 6 are arranged in parallel between the first side plate 1 and the second side plate 2 and spaced apart from each other. The top plate 4 is positioned over the first side plate 1 and the second side plate 2 so as to cover the components inside the positioning device 100. In FIG. 2, the second supporting plate 6 and the top plate 4 are not shown so as to clearly illustrate internal structural details of the positioning device 100. It is to be understood that illustration of the bracket 11 is merely exemplary and brackets having other structures can be utilized without departing from the scope of the present disclosure.

As shown in FIGS. 1 and 2, the positioning device 100 further includes a motor 40, a guide rod 10, and a transmission mechanism connected between the motor 40 and the guide rod 10. The guide rod 10 is supported by the first supporting plate 5 and the second supporting plate 6 and is capable of rotating with respect to the bracket 11 under driving of the motor 40. For example, the guide rod 10 may be mounted onto the second supporting plate 6 via a first bearing 91 and mounted onto the first supporting plate 5 via a second bearing 92. With such an arrangement, the guide rod 10 may be reliably supported by the first supporting plate 5 and the second supporting plate 6 and may rotate with respect to the bracket 11.

In some embodiments, the transmission mechanism includes a first pulley 12 connected to an output shaft of the motor 40, a second pulley 61 connected to the guide rod 10, and a timing belt 42 connected between the first pulley 12 and the second pulley 61. With such an arrangement, the guide rod 10 may be driven to rotate with respect to the bracket 11 when the motor 40 operates. It is to be understood that illustration of the transmission mechanism merely is exemplary and transmission mechanisms having other structures can be utilized without departing from the scope of the present disclosure.

The output shaft of the motor 40 may rotate in two opposite directions, so as to drive the guide rod 10 to rotate in two opposite directions. In some embodiments, the motor 40 is a pneumatic motor. The pneumatic motor has an explosion-proof function, which improves the safety performance of the positioning device 100. It is to be understood that in other embodiments, the motor 40 may be of other types, as long as it can drive the guide rod 10 to rotate in two opposite directions. The scope of the present disclosure is not intended to be limited in this respect.

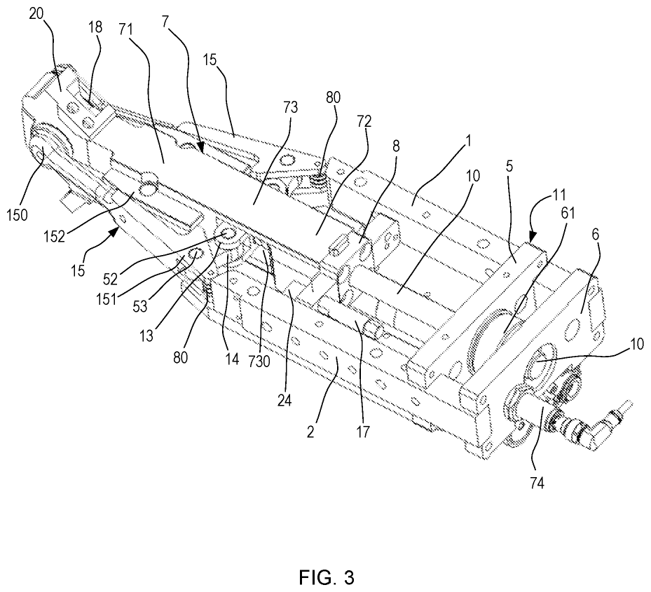

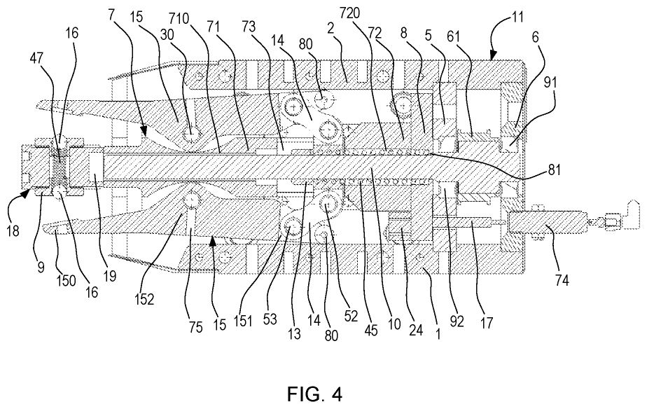

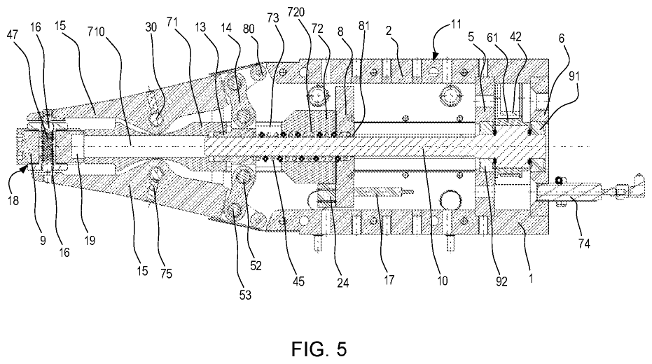

In some embodiments, as shown in FIGS. 1 and 2, the positioning device 100 further includes a connecting block 13, a follower 7, a supporting component 18, and a pair of pressing arms 15. The supporting component 18 is adapted to support the opening component 20. The pressing arms 15 are adapted to clamp the opening component 20 supported by the supporting component 18. In the following, the structure and relative arrangement of the above components will be described in detail further with reference to FIGS. 3-5. FIG. 3 illustrates a perspective view of the positioning device 100 as shown in FIG. 1 when being viewed from another direction, FIG. 4 illustrates a cross sectional view of the positioning device 100 as shown in FIG. 1 in the case that pressing arms 15 are in a separating state, and FIG. 5 illustrates a cross sectional view of the positioning device 100 as shown in FIG. 1 in the case that the pressing arms 15 are in a clamping state.

As shown in FIGS. 3-5, the connecting block 13 is connected to the guide rod 10 through threads. With the threads, the connecting block 13 may translate between a first position as shown in FIG. 4 and a second position as shown in FIG. 5 along the guide rod 10 when the guide rod 10 rotates with respect to the bracket 11. The guide rod 10 extends through the follower 7, and the follower 7 may translate with respect to the guide rod 10. Each of the pressing arms 15 includes a clamping part 150, a first connecting part 151, and a second connecting part 152. The clamping part 150 is adapted to clamp the opening component 20 supported by the supporting component 18. The second connecting part 152 is located between the clamping part 150 and the first connecting part 151 and connected to the follower 7 via a first rotating shaft 30. The first connecting part 151 is connected to the connecting block 13 via a hinge 14. The hinge 14 is connected to the connecting block 13 and the first connecting part 151 via a second a second rotating shaft 52 and a third rotating shaft 53, respectively. With such an arrangement, when the connecting block 13 is at the first position as shown in FIG. 4, the pressing arms 15 are in the separating state and the follower 7 is in a retracting state with respect to the bracket 11, and when the connecting block 13 is at the second position as shown in FIG. 5, the pressing arms 15 are in the clamping state and the follower 7 is in an extending state with respect to the bracket 11. In the separating state of the pressing arms 15, the opening component 20 will not clamped by the pressing arms 15, and in the clamping state of the pressing arms 15, the opening component 20 is clamped by the pressing arms 15.

According to embodiments of the present disclosure, when the motor 40 drives the guide rod 10 to rotate, the connecting block 13 may translate along the guide rod 10. Since the connecting block 13 is connected to the pressing arms 15 through the hinge 14 and the pressing arms 15 are in turn connected to the follower 7 through the first rotating shaft 30, the translation of the connecting block 13 will cause the pressing arms 15 to switch between the separating state and the clamping state and cause the follower 7 to switch between the retracting state and the extending state. In this way, the positioning and clamping of the opening component 20 may be implemented synchronously. In addition, the size, structural complexity and cost of the positioning device 100 are greatly reduced due to the synchronous control of the pressing arms 15 and the follower 7.

In some embodiments, the first rotating shaft 30 includes an annular groove. Accordingly, each of the pressing arms 15 further comprises a stop pin 75 arranged in the second connecting part 152 and inserted into the annular groove. The stop pin 75 may prevent the pressing arms 15 from detaching from the first rotating shaft 30. As such, the connection between the follower 7 and the pressing arms 15 will be more stable.

In some embodiments, as shown in FIGS. 3-5, the follower 7 includes a first following part 71, a second following part 72, and a third following part 73. The first following part 71 is connected to the pressing arms 15 and includes a first hole 710 suitable for insertion of the guide rod 10. The supporting component 18 is mounted at the end of the first following part 71. The supporting component 18 may be directly mounted at the end of the first following part 71 or mounted at the end of the first following part 71 via an immediate connecting component 19. The second following part 72 is spaced apart from the first following part 71 and includes a second hole 720 suitable for insertion of the guide rod 10. The third following part 73 is arranged between the first following part 71 and the second following part 72 and includes a notch 730. The connecting block 13 is received in the notch 730. Since the connecting block 13 is received in the notch 730, the space occupied by the connecting block 13 and the follower 7 can be reduced, which will further reduce the overall size of the positioning device 100.

In some embodiments, as shown in FIGS. 3-5, the positioning device 100 further includes a closing block 8 and a first spring 45. The closing block 8 is connected to an end of the second following part 72 away from the first following part 71. For example, the closing block 8 may be connected to the end of the second following part 72 via bolts. In other embodiments, the closing block 8 may be connected to the end of the second following part 72 in other manners. The scope of the present disclosure is not intended to be limited in this respect. The closing block 8 includes a protrusion 81 surrounding the guide rod 10 and partially closing the second hole 720. An end of the first spring 45 is in contact with the connecting block 13 and the other end of the first spring 45 is in contact with the protrusion 81 of the closing block 8. The first spring 45 is in a compressed state when the connecting block 13 is at the first position, as shown in FIG. 4. The first spring 45 is in a free state when the connecting block 13 is at the second position, as shown in FIG. 5. In the free state, the first spring 45 would be not compressed or be slightly compressed. When the connecting block 13 is translated from the second position to the first position with respect to the guide rod 10, the first spring 45 would gradually be compressed.

In some embodiments, as shown in FIGS. 3-5, the positioning device 100 further includes a first indicating component 17 and a first sensor 74. The first indicating component 17 is arranged at a first side of the closing block 8 away from the follower 7. The first sensor 74 is arranged on the second supporting plate 6 and configured to detect a position of the first indicating component 17 to indicate whether the follower 7 is in the retracting state with respect to the bracket 11. In the case that the follower 7 has been changed from the extending state to the retracting state with respect to the bracket 11, the output shaft of the motor 40 would stop rotating. The first indicating component 17 may be in various forms. For example, the first indicating component 17 may be an indicating rod.

In some embodiments, as shown in FIGS. 1 and 3-5, the positioning device 100 further includes a second indicating component 24 and a second sensor 84. The second indicating component 24 is arranged at a second side of the closing block 8 opposite to the first side. The second sensor 84 is arranged on the top plate 4 and configured to detect a position of the second indicating component 24 to indicate whether the follower 7 is in the extending state with respect to the bracket 11. In the case that the follower 7 has been changed from the retracting state to the extending state with respect to the bracket 11, the output shaft of the motor 40 would stop rotating. The second indicating component 24 may be in various forms. For example, the second indicating component 24 may be an indicating block.

In some embodiments, as shown in FIGS. 4-5, the supporting component 18 includes a plugging block 9, a pair of restricting elements 16, and a second spring 47. The plugging block 9 is connected to the end of the follower 7. The plugging block 9 is adapted to support an inner surface of the opening component 20. The shape of the plugging block 9 matches with that of the opening component 20 so as to reliably support the opening component 20. The restricting elements 16 are arranged in the plugging block 9 and capable of partially protruding out of plugging block 9. The restricting elements 16 may be of various shapes. For example, each of the restricting elements 16 may be of a spherical shape. The second spring 47 is arranged between the restricting elements 16 and configured to apply a pushing force to the pair of restricting elements 16 such that the pair of restricting elements 16 partially protrude out of the plugging block 9 to restrict the movement of the opening component 20 supported by the plugging block 9. During the process of mounting the opening component 20 onto the supporting component 18, the restricting elements 16 would be pressed into the plugging block 9. After the opening component 20 has reached a desired position, the restricting elements 16 would protrude out of the plugging block 9 and be received by corresponding holes on the opening component 20. In this way, the movement of the opening component 20 supported by the plugging block 9 can be restricted by the restricting elements 16.

In some embodiments, as shown in FIGS. 2-5, each of the pressing arms 15 further includes a roller 80 arranged close to an edge of the second connecting part 152 and configured to guide the movement of the respective pressing arm 15 with respect to the bracket 11. When the connecting block 13 is translating along the guide rod 10, the roller 80 may rotate along the bracket 11 and thus guide the movement of the respective pressing arm 15 with respect to the bracket 11.

Hereinafter, the example operating process of the positioning device 100 will be described with reference to FIGS. 4 and 5.

As shown in FIG. 4, the connecting block 13 is at the first position with respect to the guide rod 10. At this time, the pressing arms 15 are in the separating state, and the follower 7 is in the retracting state with respect to the bracket 11. After the opening component 20 is mounted onto the supporting component 18, the output shaft of the motor 40 may rotate along a first direction, such that the connecting block 13 translates in a direction away from the first supporting plate 5. The connecting block 13 may drive the pressing arms 15 to move in the direction away from the first supporting plate 5 via the hinge 14. Since the pressing arms 15 are connected to the follower 7, the follower 7 will translate together with the pressing arms 15. After the roller 80 of the pressing arms 15 has moved out of the bracket 11, the connecting block 13 may drive the pressing arms 15 to rotate towards each other via the hinge 14. Finally, the connecting block 13 will reach the second position with respect to the guide rod 10, and the opening component 20 supported by the supporting component 18 will be clamped by the pressing arms 15 and ready for welding or assembling, as shown in FIG. 5.

As shown in FIG. 5, the connecting block 13 is at the second position with respect to the guide rod 10. At this time, the pressing arms 15 are in the clamping state, and the follower 7 is in the extending state with respect to the bracket 11. When the opening component 20 needs to be released, the output shaft of the motor 40 may rotate along a second direction opposite to the first direction, such that the connecting block 13 translates in a direction towards the first supporting plate 5. Before the pressing arms 15 move into the bracket 11, the connecting block 13 may drive the pressing arms 15 to rotate away from each other via the hinge 14. After the roller 80 of the pressing arms 15 has moved back into the bracket 11, the connecting block 13 may drive the pressing arms 15 to move in the direction towards the first supporting plate 5 via the hinge 14, and the follower 7 will translate together with the pressing arms 15. Finally, the connecting block 13 will reach the first position with respect to the guide rod 10, and the opening component 20 supported by the supporting component 18 will be released by the pressing arms 15, as shown in FIG. 4.

It should be appreciated that the above detailed embodiments of the present disclosure are only to exemplify or explain principles of the present disclosure and not to limit the present disclosure. Therefore, any modifications, equivalent alternatives and improvements, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A positioning device for clamping an opening component, comprising:
a bracket;
a guide rod supported by the bracket and being capable of rotating with respect to the bracket under driving of a motor;
a connecting block connected to the guide rod through threads and being capable of translating between a first position and a second position along the guide rod when the guide rod rotates with respect to the bracket;
a follower through which the guide rod extends, the follower being capable of translating with respect to the guide rod;
a supporting component connected to an end of the follower and configured to support the opening component; and
a pair of pressing arms each comprising a clamping part configured to clamp the opening component supported by the supporting component, a first connecting part connected to the connecting block via a hinge, and a second connecting part located between the clamping part and the first connecting part and connected to the follower via a first rotating shaft, such that the pair of pressing arms are in a separating state and the follower is in a retracting state with respect to the bracket when the connecting block is at the first position, and the pair of pressing arms are in a clamping state and the follower is in an extending state with respect to the bracket when the connecting block is at the second position.

2. The positioning device according to claim 1, wherein the follower comprises:
a first following part connected to the pair of pressing arms and comprising a first hole suitable for insertion of the guide rod, wherein the supporting component is mounted on the first following part;
a second following part spaced apart from the first following part and comprising a second hole suitable for insertion of the guide rod; and
a third following part arranged between the first following part and the second following part and comprising a notch, wherein the connecting block is received in the notch.

3. The positioning device according to claim 2, further comprising:
a closing block connected to an end of the second following part away from the first following part and comprising a protrusion surrounding the guide rod and partially closing the second hole; and
a first spring (45) having an end contacting the connecting block and another end contacting the protrusion of the closing block and configured to be in a compressed state when the connecting block is at the first position and in a free state when the connecting block is at the second position.

4. The positioning device according to claim 3, further comprising:
a first indicating component arranged at a first side of the closing block away from the follower; and
a first sensor configured to detect a position of the first indicating component to indicate whether the follower is in the retracting state with respect to the bracket.

5. The positioning device according to claim 4, further comprising:
a second indicating component arranged at a second side of the closing block opposite to the first side; and
a second sensor configured to detect a position of the second indicating component to indicate whether the follower is in the extending state with respect to the bracket.

6. The positioning device according to claim 1, wherein the supporting component comprises:
a plugging block connected to the end of the follower;
a pair of restricting elements arranged in the plugging block and being capable of partially protruding out of plugging block; and
a second spring arranged between the pair of restricting elements and configured to apply a pushing force to the pair of restricting elements such that the pair of restricting elements partially protrude out of the plugging block to restrict the movement of the opening component supported by the plugging block.

7. The positioning device according to claim 6, wherein each of the pair of restricting elements is of a spherical shape.

8. The positioning device according to claim 1, wherein each of the pair of pressing arms further comprises a roller arranged close to an edge of the second connecting part and configured to guide the movement of the respective pressing arm with respect to the bracket.

9. The positioning device according to claim 1, wherein the first rotating shaft comprises an annular groove, and
wherein each of the pair of pressing arms further comprises a stop pin arranged in the second connecting part and inserted into the annular groove.

10. The positioning device according to claim 1, wherein the motor is a pneumatic motor.
